(19) United States
(12) Patent Application Publication
(10) Pub. No.: US 2013/0078453 A1
(43) Pub. Date: Mar. 28, 2013

(54) DRILLING ENTRY BOARD FOR PRINTED CIRCUIT BOARD

(71) Applicants: Chung-Hao Chang, Taoyuan Hsien (TW); Jia-Wei Cao, Taoyuan Hsien (TW); Han-Shiang Huag, Taoyuan Hsien (TW); Chia-Hsiu Yeh, Taoyuan Hsien (TW)

(72) Inventors: Chung-Hao Chang, Taoyuan Hsien (TW); Jia-Wei Cao, Taoyuan Hsien (TW); Han-Shiang Huag, Taoyuan Hsien (TW); Chia-Hsiu Yeh, Taoyuan Hsien (TW)

(21) Appl. No.: 13/396,308

(22) Filed: Feb. 14, 2012

(30) Foreign Application Priority Data
Sep. 26, 2011 (TW) 100134508

(51) Int. Cl. B32B 3/00; B32B 27/38; B32B 15/08

(52) U.S. Cl. 428/336; 428/457; 428/413; 428/461

(57) ABSTRACT

A drilling entry board for a printed circuit board (PCB) includes a metal substrate and a lubricating copolymer. The lubricating copolymer is bonded on the metal substrate surface and comprises a water-soluble structure and a water insoluble structure.

### BACKGROUND

1. Field of the Invention

The present invention relates to a drilling entry board applies for printed circuit board (PCB), in which a lubricated copolymer own water-soluble and water insoluble structure, the copolymer have lubrication and easy-to-wash properties of the water-soluble structure and increase drill needle stabilizing and metal foil bonding properties of the water insoluble structure. According to the structure proportion or the molecular weight of the present invention, manufacturing procedures can be reduced, the production performance can be improved, the drilling precision and accuracy can be stabilized in drilling application, and the drilling needle can be retard broken and increase used times, moreover, the disadvantages that the lubricating copolymer is dropped off or curled after drilling will not occur.

2. Description of Related Art

In recent years, the development of electronic products trends in light, thin and multiple functions and high speed, so that the proportion of number and density of micro-pores of a PCB is dramatically increased. Based on this trend, efficacies such as quality of drilled holes, precision, and used life of the drilling bit are important factor. However, conventional drilling entry boards such as aluminum foil or phenolic resin, each are not applicable to the required quality of drilled holes etc. If the conventional drilling entry boards is reluctantly used will during drilling needle easily broken and the hole quality easily deviated.

Today, the drilling entry boards (most of which are aluminum entry boards) of different types and constitutions are PCB process required, but a few stable and applicable drilling metal entry boards exist, during by a formula of lubrication layer is complex and functions of buffering to downward drilling pressure, lubricating the drilling needle (reducing the drilling needle abrasion), beside adhering on the metal foil (heat-dissipation function of the drilling needle) are very complex. For example, a drilling plate made by a water soluble lubrication mixture, synthetic wax, filler and additives, coating on paper sheet has heat of the drilling needle cannot be dissipated and the adhesion problem. Beside, polyethylene glycol or poly (ether ester) is used to improve the adhesion problem, but the chips on the drilling needle cannot be removed and the hole deviation problem exists. When a drilling cover plate is made of the following three different combinations: a film made by a water-soluble resin mixed with a water insoluble lubricant, a composite material of the film and an aluminum foil, and thermosetting resin coated between the film and the aluminum foil, the formula and generation are complex and the drilling needle easily slides, so that the hole is easily deviated or the drilling needle is easily broken due to the high hardness of the bonded thermosetting resin layer.

In view of this, the present invention provides a drilling entry board that can be effectively bonded on a metal foil, functions of lubricating the drilling needle, heat-dissipation, reducing the needle breaking rate and improving the drilling precision. Moreover, it can meet the drilling requirements of the high number of holes and the low deviation, greatly increase the production speed, reduce the complex processes and after water washing can be reused drilling needle and recycle drilling entry board.

### SUMMARY OF THE INVENTION

The object of the present invention is to provide a drilling entry board for PCB process, which has a good bonding force with a metal foil without a conventional base coating, thereby avoiding a conventional complicated process requiring the base coating, advantages of increased drilling precision, reduced drilling needle breaking rate, reduced micro hole roughness in drilling applications and can be recycle.

In order to achieve the above objectives, the present invention provides a drilling entry board for PCB process. The drilling entry board includes a base metal layer and a lubricating copolymer layer. The lubricating copolymer is coated on the metal substrate surface and comprising a water-soluble structure and a water insoluble structure.

In practice, the compounds of copolymer structure have the water-soluble properties and the water insoluble properties are formed by formulating a water-soluble structure and a water insoluble structure. The water-soluble structure prefer selected from the group consisting of vinyl alcohol, sodium acrylate, acrylamide, vinyl pyrrolidone and the water insoluble structure prefer selected from the group consisting of acrylic acid, ethylene rhodanate and maleimide.

In practice, the compounds of copolymer structure have the water-soluble properties and the water insoluble properties are synthesis by cross-linking agent to polymerization water-soluble structure and water insoluble structure. The water-soluble structure prefer selected ethylene glycol, propylene glycol, ethylene oxide, propylene oxide, ether ester, carboxymethyl cellulose, polytetramethylene glycol and poly (ether ester). The water insoluble structures prefer selected phenol, epoxy, unsaturated polyester, carbamate and silicone. The cross-linking agents prefer selected bismaleic anhydride, anhydride, chloride, and epoxy compound.

In practice, the water-soluble structure accounts for 5%-90% of the lubricating copolymer.

In practice, the compounds of copolymer structure have the water-soluble properties and the water insoluble properties are synthesis by adding an initiator to polymerization water-soluble monomers and water insoluble monomers. The water insoluble monomer prefer selected vinyl ether ester, vinyl alcohol-co-acrylate, acrylic acid-co-acrylate, acrylate-co-acrylate, acrylamide-co-acrylate, allylamine and vinyl pyrrolidone-co-acrylate and the initiator prefer selected from the group consisting of an azo compound and a peroxide.

In practice, the lubricating copolymer is uniformly coated on the substrate surface to a thickness of 5 μm to 250 μm through a film making method such as roll coating, spin coating, laminating, spraying, or screen printing.

In practice, the metal substrate is a metal foil, which prefer selected from pure aluminum and a copper and magnesium alloy.

In practice, an additive may be additionally added in the lubricating copolymer, moreover the additive prefers surfactant, filler, lubricant or other additives.

To further understand the present invention, in the following preferred embodiments, specific contents and effects of the present invention are described in details with reference to accompanying drawings and figure numbers.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic structural diagram according to an embodiment of the present invention.

### DETAILED DESCRIPTION

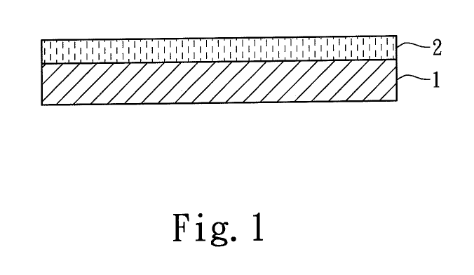

FIG. 1 shows an embodiment of a drilling entry board for PCB process according to the present invention. Referring to FIG. 1, the drilling entry board includes a metal substrate 1 and a lubricating copolymer 2.

The metal substrate 1 is a metal foil, which prefer selected from pure aluminum and a copper and magnesium alloy, and has a thickness of 5 μm to 500 μm.

The lubricate copolymer 2 is bonded on the metal substrate 1. The lubricate copolymer 2 is synthesis by water-soluble properties and water insoluble properties through reaction, and has the following structural formula:

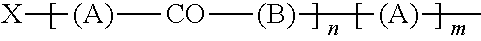

where n=1-10000, m=1-10000, n/m=1-100, and X=a dialkylene group, cyano group or epoxy function group.

In implementation, the compounds of copolymer properties have (that is, the lubricating copolymer) the water-soluble property and the water insoluble property may be formed in the following method.

A. The compounds of copolymer structure are synthesis by water-soluble structure and a water insoluble structure.

The water-soluble structure prefer selected from the group consisting of vinyl alcohol, sodium acrylate, acrylamide, and vinyl pyrrolidone, and the water insoluble structure prefer selected from the group consisting of acrylic acid, ethylene rhodanate, and maleimide. The water-soluble structure accounts for 5%-90% of the lubricating copolymer.

B. The compounds are synthesis by cross-linking agent to polymerization water-soluble structure and water insoluble structure.

The water-soluble structure prefer selected ethylene glycol, propylene glycol, ethylene oxide, propylene oxide, ether ester, carboxymethyl cellulose, polytetramethylene glycol and poly (ether ester). The water insoluble structures prefer selected phenol, epoxy, unsaturated polyester, carbamate, alcohol acid, and silicone. The cross-linking agent prefer selected bis-maleic anhydride, acid anhydride, chloride and epoxy function group. The water-soluble structure accounts for 5%-90% of the lubricating copolymer.

C. The compounds are synthesis by initiator agent to polymerization water-soluble and water insoluble monomers.

The water-soluble monomers have the following structural formula:

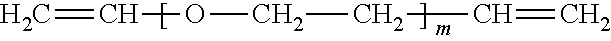

The water-soluble monomers prefer selected vinyl ether ester, vinyl alcohol-co-acrylate, acrylic acid-co-acrylate, acrylate-co-acrylate, acrylamide-co-acrylate, allylamine and vinyl pyrrolidone-co-acrylate. The initiators prefer selected azo compound (for example, azodiisobutyronitrile or azodiisoheptonitrile) and a peroxide (for example, acyl peroxide, alkyl peroxide, peroxyester, hydroperoxide, peroxydicarbonate, or ketone peroxide).

Moreover, the lubrication copolymer 2 is uniformly coated on the metal substrate surface 1 to a thickness 5 μm to 250 μm through a film making method such as roll coating, spin coating, laminating, spraying, or screen printing. Also, an additive may be additionally added in the lubricating copolymer 2. The additive may be one of a surfactant, a filler, a lubricant, and other additives and is mainly used for improving the rinsing effect of the drill needle at room temperature. The addition proportion should not affect the film forming property of the resin, and is preferably 10% or less, and more preferably 5% or less.

In Embodiment 1 and Embodiment 2, the copolymer is synthesized through reaction between a water-soluble structure and a water insoluble structure. In Embodiment 3, the copolymer is formed by water-soluble monomers of a water-soluble structure and a water insoluble structure. The embodiments of the present invention are described as follows.

Embodiment 1: To 1 mol vinyl alcohol (a water-soluble structure) having a molecular weight of 2000, 1 mol acrylic acid (a water insoluble structure) was added. After a period of time of reaction at a temperature, a lubricating copolymer was obtained. A hardening agent and a catalyst were added in the lubricating copolymer, the resulting product was directly coated on a metal substrate surface (for example, a micrometer aluminum foil), and then baked at a high temperature, so as to obtain a drilling entry board.

Embodiment 2: To 2 mol polyethyleneglycol (a water-soluble structure) having a molecular weight of 2000, 1 mol bisphenol A (a water insoluble structure) and 4 mol of epoxy chloropropane (a cross-linking agent) were added. After a period of time of reaction at a temperature, a lubricating copolymer was obtained. The reaction formula is shown as follows.

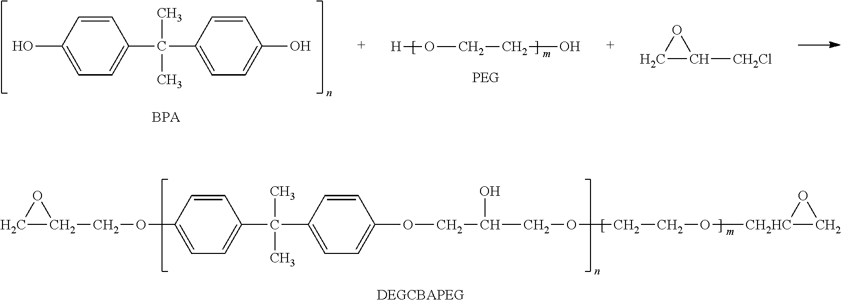

A hardening agent (for example, amine or acid anhydride) and a catalyst (for example, imidazole) were added in the lubricating copolymer, the resulting product was directly coated on a metal substrate surface (for example, aluminum foil), and then baked at a high temperature, so as to obtain a drilling entry board.

Embodiment 3: To 1 mol vinyl ether ester (a water-soluble monomer) having a molecular weight of 2000, azodiisobutyronitrile (an initiator) was added. After a period of time of pre-reaction, the resulting product was coated on a metal substrate surface and baked at a high temperature, so as to obtain a drilling entry board.

Therefore, through the design of the present invention, a good bonding force with the metal substrate 1 (the metal foil) is achieved without a conventional base coating, thereby avoiding a conventional complicated process requiring the base coating, and having advantages of increased drilling precision, reduced drilling needle breaking rate, reduced micro-pore roughness in drilling applications, and being environmental protection and being capable of being recovered. Meanwhile, when the lubricating copolymer 2 according to the present invention is used as a lubrication layer of the drilling entry board, excellent effects of buffering a drilling impulse force, lubricating the drill needle and binding the metal foil for heat dissipation can be easily achieved by adjusting a structural proportion of the lubricating copolymer 2.

While the present invention has been described with reference to the embodiments and technical means thereof, various changes and modifications can be made based on the disclosure or teaching described herein. Any equivalent changes made based on the concept of the present invention having their effect without departing from the spirit encompassed by the specification and drawings should be construed as falling within the scope of the present invention as defined by the appended claims.

According to the aforementioned disclosure, the present invention surely can achieve the expected objectives to provide a drilling entry board for a PCB, which has industrial applicability. Thus, the application for a patent is filed according to the law.

It should be understood that different modifications and variations could be made from the disclosures of the present invention by the people familiar in the art without departing the spirit of the present invention.

What is claimed:

1. A drilling entry board for a printed circuit board (PCB), comprising:
a metal substrate surface; and
a lubricating copolymer, bonded on the metal substrate surface.

2. The drilling entry board for a PCB according to claim 1, wherein the lubricating copolymer comprises a water-soluble structure and a water insoluble structure.

3. The drilling entry board for a PCB according to claim 2, wherein the water-soluble structure prefer selected from the group consisting of vinyl alcohol, sodium acrylate, acrylamide, and vinyl pyrrolidone and the water insoluble structure prefer selected from the group consisting of acrylic acid, ethylene rhodanate and maleimide.

4. The drilling entry board for a PCB according to claim 1, wherein the lubricating copolymer further comprises a cross-linking agent, and is formed by formulating a water-soluble structure, a water insoluble structure, and the cross-linking agent.

5. The drilling entry board for a PCB according to claim 4, wherein the water-soluble structure is selected from the group consisting of ethylene glycol, propylene glycol, ethylene oxide, propylene oxide, ether ester, carboxymethyl cellulose, polytetramethylene glycol, and poly (ether ester), the water insoluble structure is selected from the group consisting of phenol, epoxy, unsaturated polyester, carbamate, alcohol acid, and silicone, and the cross-linking agent is selected from the group consisting of bis-maleic anhydride, acid anhydride, chloride, and an epoxy compound.

6. The drilling entry board for a PCB according to claim 2, wherein the lubricating copolymer comprises the water-soluble structure in a proportion of 5%-90%.

7. The drilling entry board for a PCB according to claim 4, wherein the lubricating copolymer comprises the water-soluble structure in a proportion of 5%-90%.

8. The drilling entry board for a PCB according to claim 1, wherein the lubricating copolymer is formed by adding an initiator in water-soluble monomers capable of forming water-soluble and water insoluble copolymers.

9. The drilling entry board for a PCB according to claim 8, wherein the water-soluble monomer is selected from the group consisting of vinyl ether ester, vinyl alcohol-co-acrylate, acrylic acid-co-acrylate, acrylate-co-acrylate, acrylamide-co-acrylate, allylamine, and vinyl pyrrolidone-co-acrylate, and the initiator is selected from the group consisting of an azo compound and a peroxide.

10. The drilling entry board for a PCB according to claim 1, wherein the lubricating copolymer is uniformly coated on the metal substrate surface to a thickness of 5 μm to 250 μm through a film making method such as roll coating, spin coating, laminating, spraying, or screen printing.

11. The drilling entry board for a PCB according to claim 1, wherein the metal substrate surface is a metal foil, and the metal is selected from pure aluminum and a copper and magnesium alloy.

12. The drilling entry board for a PCB according to claim 1, wherein an additive is additionally added in the lubricating copolymer, and the additive is one of a surfactant, a filler, a lubricant, and other additives.
